(19) United States
(12) Patent Application Publication
(10) Pub. No.: US 2023/0331538 A1
(43) Pub. Date: Oct. 19, 2023

(54) LIQUID SUPPLY SYSTEM AND LIQUID LOSS REDUCTION METHOD

(71) Applicants: Asahi Group Holdings, Ltd., Tokyo (JP); ASAHI BREWERIES, LTD., Tokyo (JP)

(72) Inventors: Naoyuki YAMASHITA, Moriya-shi, Ibaraki (JP); Junichi KITANO, Moriya-shi, Ibaraki (JP); Takashi WADA, Kobe-shi, Hyogo (JP); Kenji KUSUNOKI, Kobe-shi, Hyogo (JP); Takashi NISHIO, Kobe-shi, Hyogo (JP)

(73) Assignees: Asahi Group Holdings, Ltd., Tokyo (JP); ASAHI BREWERIES, LTD., Tokyo (JP)

(21) Appl. No.: 18/028,078

(22) PCT Filed: Sep. 15, 2021
(86) PCT No.: PCT/JP2021/033927

§ 371 Date: Mar. 23, 2023

(30) Foreign Application Priority Data
Sep. 25, 2020 (JP) 2020-160868

(51) Int. Cl. B67D 1/12; B67D 1/04

(52) U.S. Cl. CPC B67D 1/1202; B67D 1/04; B67D 1/1247; B67D 1/1252; B67D 1/1277

(57) ABSTRACT

There are provided a liquid supply system and a liquid loss reduction method capable of reducing a liquid loss caused when a liquid storage container is replaced. A liquid supply system (101) that transfers a liquid in a storage container (10) through a supply pipe (30), and dispenses the liquid from a dispensing outlet in a dispensing device (50). The liquid supply system includes a spout prevention unit (110) that is installed in the supply pipe, has a predetermined internal volume, and prevents a pressurized gas from being spouted from the dispensing outlet, a liquid-absence detection device (120) that is installed between the storage container and the spout prevention unit, and detects absence of the liquid in the storage container, and a control device (130) that is electrically connected to the liquid-absence detection device, and gives instructions for closing a flow path in the dispensing device in response to the detection of the absence of the liquid in the storage container.

### TECHNICAL FIELD

The present invention relates to a liquid supply system that transfers a liquid in a storage container with a gas and dispenses the liquid from a dispensing device into a drinking container, and more particularly to a liquid supply system capable of reducing a liquid loss caused when the storage container is replaced, and a liquid loss reduction method executed in the liquid supply system.

### BACKGROUND ART

In a restaurant, a liquid supply system is generally used as a device for providing a liquid such as beer. Referring to FIG. 6, with the beer taken as an example, a liquid supply system 70 includes a carbon dioxide gas cylinder 15 as a pressurization source, a beer barrel 10 filled with the beer, a supply pipe 30, and a beer dispenser 50. The liquid supply system pressurizes the beer in the beer barrel 10 with a carbon dioxide gas of the carbon dioxide gas cylinder 15, and transfers the beer to the beer dispenser 50 through the supply pipe 30 with the carbon dioxide gas. The beer dispenser 50 has a beer cooling pipe 52 installed in a cooling tank 51, a refrigeration machine 53, and a dispensing outlet 54. The beer dispenser freezes a part of a cooling water in the cooling tank 51 by the refrigeration machine 53, cools the beer while causing the beer to flow in the beer cooling pipe 52 with a lever operation at the dispensing outlet 54, and dispenses the beer to a drinking container such as a beer mug.

In this manner, the beer within the beer barrel is provided to a customer.

### PRIOR ART DOCUMENTS

### Patent Documents

Patent Document 1: JP 2003-261200 A

### SUMMARY OF THE INVENTION

### Problems to be Solved by the Invention

In the liquid supply system 70 as described above, for example, when the beer in the beer barrel 10 runs out during dispensing of the beer from the dispensing outlet 54, there is a possibility that the carbon dioxide gas pressurizing the beer is spouted from the dispensing outlet 54 and the beer having been dispensed into the beer mug is scattered. In order to prevent such jetting, some spout prevention devices 60 that electrically or mechanically detect that the beer in the beer barrel runs out and stop a dispensing operation have already been proposed and used. Each of such spout prevention devices 60 is installed in a pipe between an outlet of the beer barrel 10 and an inlet of the beer dispenser 50.

When there is no beer in the beer barrel 10 and replacement with a new beer barrel filled with beer is performed, beer present in a pipe 30a between the outlet of the empty beer barrel and the inlet of the spout prevention device 60 is discarded particularly in the case of the spout prevention device 60 of a type that electrically detects the absence of the beer in the beer barrel.

In either of the spout prevention devices 60 that electrically or mechanically detect the absence of the beer, the beer present within the pipe between the spout prevention device 60 and the dispensing outlet 54 of the beer dispenser 50 needs to be discarded in many cases. That is, when the dispensing outlet 54 remains opened even after the activation of the spout prevention device 60, since there is no pressurizing force with the carbon dioxide gas having acted on the beer so far, there is a high possibility that the carbon dioxide gas in the beer is released and the beer becomes so-called “flat” or “stale” beer, and there is a concern that quality deteriorates. A length of the pipe in the above section ranges from ten meters to twenty meters since this section particularly has the long cooling pipe 52.

With respect to the pipe 30 and a pipe line in the beer dispenser 50, from which the beer is discarded and which becomes empty, it is necessary to perform a so-called “introducing” operation of the beer from a new beer barrel and to transfer the introduced beer with the carbon dioxide gas. In this “introducing” operation, since a mixed liquid with the beer and the carbon dioxide gas mixed flows in the pipe line, the beer in the “introducing” operation is also discharged and discarded from the dispensing outlet 54. Therefore, also in the “introducing” operation, there is a beer amount that is not provided for drinking.

As described above, there is a problem that beer that is not used for drinking and is lost is generated by replacing the beer barrel 10 once in the related art.

The present invention has been made to solve such a problem, and an object of the present invention is to provide a liquid supply system capable of reducing a liquid loss caused when a liquid storage container such as a beer barrel is replaced, and a liquid loss reduction method executed in the liquid supply system.

### Means for Solving the Problems

To achieve the aforementioned object, the present invention has a configuration to be described below.

That is, a liquid supply system according to one aspect of the present invention is a liquid supply system that supplies a liquid in a storage container to a dispensing device through a supply pipe with a pressurized gas, and dispenses the liquid to a drinking container from a dispensing outlet in the dispensing device, the liquid supply system comprising:
a spout prevention unit being installed in the supply pipe, having a tubular shape with a predetermined internal volume, having a liquid inlet and a liquid outlet connected to the supply pipe, and preventing the pressurized gas from being spouted from the dispensing outlet;
a liquid-absence detection device being installed between the storage container and the spout prevention unit, and detecting absence of the liquid in the storage container; and
a control device being electrically connected to the liquid-absence detection device, and giving instructions to close a flow path in the dispensing device in response to the detection of the absence of the liquid in the storage container.

### Effects of the Invention

According to the above aspect, the spout prevention unit, the liquid-absence detection device, and the control device are provided, and thus, it is possible to give instructions for closing the flow path in the dispensing device by detecting that the liquid in the storage container runs out. Accordingly, it is possible to prevent quality deterioration of the liquid remaining between the spout prevention unit and the dispensing outlet, and then it is not necessary to discard the liquid during the replacement of the storage container. Therefore, it is possible to reduce the amount of liquid loss as compared with the related art.

Since the spout prevention unit is provided, it is also possible to prevent the pressurized gas from being spouted from the dispensing outlet.

### BRIEF DESCRIPTION OF THE DRAWINGS

FIG. 1 is a diagram illustrating a configuration example of a liquid supply system according to an embodiment of the present invention.

FIG. 2 is a diagram illustrating a schematic configuration of a spout prevention unit illustrated in FIG. 1.

FIG. 3A is a perspective view illustrating a schematic configuration of a liquid-absence detection device illustrated in FIG. 1.

FIG. 3B is a diagram illustrating a schematic configuration and an operation of the liquid-absence detection device illustrated in FIG. 1.

FIG. 4 is a diagram illustrating a schematic configuration of a spout prevention unit as an alternative to the spout prevention unit illustrated in FIG. 1.

FIG. 5A is a diagram illustrating a schematic configuration and an operation of a spout prevention unit as an alternative to the spout prevention unit illustrated in FIG. 1.

FIG. 5B is a diagram illustrating a schematic configuration and an operation of a spout prevention unit as an alternative to the spout prevention unit illustrated in FIG. 1.

FIG. 6 is a diagram illustrating a configuration example of a liquid supply system in the related art.

### EMBODIMENTS OF THE INVENTION

A liquid supply system according to an embodiment of the present invention and a liquid loss reduction method executed in the liquid supply system will be described below with reference to the drawings. In the drawings, the same or similar components are denoted by the same reference symbols. In order to avoid the following description from being unnecessarily redundant and to facilitate the understanding of those skilled in the art, detailed description of well-known matters and redundant description of substantially the same configuration may be omitted. The following description and the contents of the accompanying drawings are not intended to limit the subject matter described in the claims.

In the following embodiment, beer is used as an example of a liquid to be handled, but the liquid is not limited to beer. Alcohol drinks such as low-malt beer, liqueur, shochu highball, whiskey, and wine, drinking water, soft drinks, and carbonated drinks may be used as the liquid.

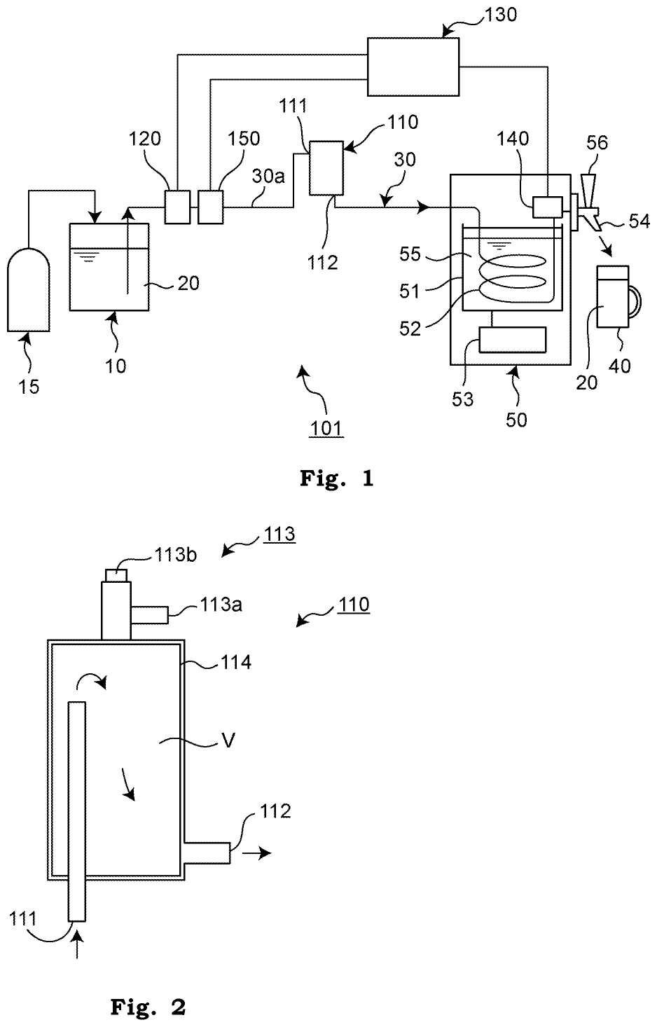

A liquid supply system 101 according to an embodiment illustrated in FIG. 1 will be described. The liquid supply system 101 is based on the liquid supply system 70 described already with reference to FIG. 6, and has a configuration to which some components are added as will be described below.

That is, as illustrated in FIG. 1, the liquid supply system 101 has a configuration in which a new spout prevention unit 110 in place of the spout prevention device 60, a liquid-absence detection device 120, and a control device 130 are added based on an existing component including a storage container 10, a pressurization source 15, a supply pipe 30, and a dispensing device 50. As a modified configuration example of the liquid supply system 101, a configuration in which a closing device 140 and a pressure detection device 150 are further provided can be adopted.

These components will be sequentially described below.

Initially, although repeated, the existing component is a system that supplies, that is, transfers a liquid (beer in the embodiment as described above) 20 within the storage container 10 to the dispensing device 50 through the supply pipe 30 by pressurizing the liquid with the pressurization source 15 and dispenses the liquid from the dispensing device 50 to a drinking container (for example, a beer mug) 40. Here, in the embodiment, the storage container 10 is a stainless steel container called a beer barrel filled with beer by a beer manufacturer, and has a capacity of, for example, 5 liters, 10 liters, or 19 liters. The pressurization source 15 is a carbon dioxide gas cylinder. The supply pipe 30 is a flexible resin pipe made of, for example, polyamide, polyurethane, or polyester which enables beer to flow between the storage container 10 and the dispensing device 50. It is preferable that all inner diameters of flow passages of a fluid, excluding the spout prevention unit 110, from the supply pipe 30 to a liquid dispensing outlet 54 of the dispensing device 50 are designed to have the same dimension such that cleaning operation with using a sponge becomes easy.

In the embodiment, as an example of the above mentioned dispensing device 50, a beer dispenser (may be referred to as a “beer server”) is adopted and will be described (accordingly, hereinafter, it may be referred to as the beer dispenser 50). As already described above, the beer dispenser 50 includes a liquid cooling pipe (beer cooling pipe in the embodiment) 52 disposed inside a cooling tank 51, a refrigeration machine 53, and the liquid dispensing outlet 54. The beer dispenser freezes a part of a cooling water 55 within the cooling tank 51 by using the refrigeration machine 53, and cools the liquid (beer) 20 passing through the beer cooling pipe 52 by using the cooling water 55. With a lever 56 at the dispensing outlet 54 operated, the beer 20 transferred with a carbon dioxide gas of the pressurization source 15 passes through the beer cooling pipe 52, is cooled, and is dispensed into the drinking container 40 such as the beer mug. And then the beer is served to a customer.

The beer dispenser 50 is generally used in an environment in which an external air temperature is equal to or higher than 5° C. and is equal to or lower than 40° C. The liquid handled by the dispensing device 50 is not limited to the beer, and may be such as a drinking water described above. In the embodiment, the beer dispenser 50 also cools the beer of a target liquid, but the dispensing device 50 included in the embodiment may heat the target liquid or keep the target liquid warm.

Next, as illustrated in FIG. 2, the spout prevention unit 110 is installed in the supply pipe 30, has a tubular shape such as a cylinder and a square cylinder having a predetermined internal volume V, and has a liquid inlet 111 connected to the supply pipe 30 and a liquid outlet 112 connected to the supply pipe 30. The spout prevention unit 110 having such a configuration is an alternative to the spout prevention device 60 described with reference to FIG. 6, and for example, when the beer within the beer barrel 10 runs out during the dispensing of the beer from the dispensing outlet 54, the carbon dioxide gas transferring the beer is prevented from being spouted out from the dispensing outlet 54. Although this point will be described in detail in an operation description to be described later, the spout prevention unit 110 functions as a buffer to prevent the carbon dioxide gas flowing into the spout prevention unit 110 from the liquid inlet 111 from directly flowing from the liquid outlet 112 to the dispensing device 50 side.

The spout prevention unit 110 also has an exhaust mechanism 113 that exhausts a pressurized gas (in the embodiment, carbon dioxide gas) flowing into the spout prevention unit 110 to an outside of the spout prevention unit 110 at an upper portion of the spout prevention unit, and further has a visual recognition unit 114 that is provided at least adjacent to the exhaust mechanism 113 and through which an inside of the spout prevention unit 110 can be seen.

In the present embodiment, the exhaust mechanism 113 includes a discharge outlet 113a and an air release lever 113b for an exhausting operation that opens and closes the discharge outlet 113a. In the present embodiment, the spout prevention unit 110 is formed by using a transparent cylindrical body except for the upper and lower portions of the spout prevention unit 110, so that the visual recognition unit 114 is formed over substantially the entire length of the spout prevention unit 110.

In FIG. 2, although the liquid inlet 111 extends to the upper portion within the spout prevention unit 110, this is merely a configuration example, and the liquid inlet 111 is not limited to this structure. An operation function of the exhaust mechanism 113 will be described later.

Next, the liquid-absence detection device 120 is a device that is installed between the storage container 10 and the spout prevention unit 110 and detects that the liquid 20 within the storage container 10 runs out. The liquid-absence detection device 120 can adopt specifically, for example, the following configuration.

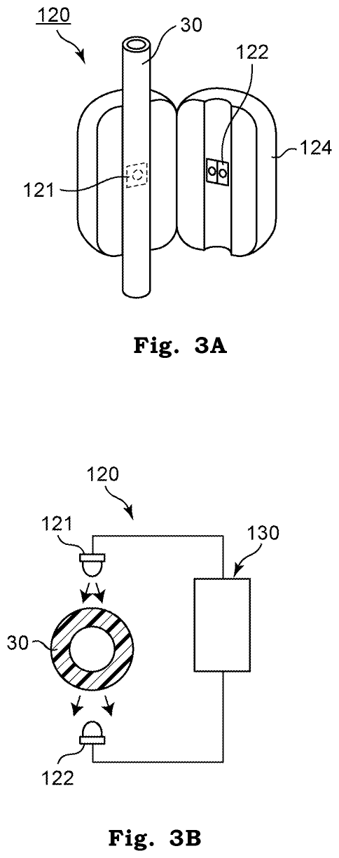

That is, the liquid-absence detection device 120 includes a light emitting element 121 and a light receiving element 122 as illustrated in FIGS. 3A and 3B as an example. The light emitting element 121 and the light receiving element 122 are disposed in a housing 124 which is disposed so as to sandwich the resin supply pipe 30 connected to an outlet of the storage container 10 in a state that the elements 121 and 122 are arranged facing each other across the beer passing through the supply pipe 30. The light emitting element 121 emits infrared light, and the light receiving element 122 receives the emitted infrared light. The light emitting element 121 and the light receiving element 122 are electrically connected to the control device 130 having a function of a liquid state determination unit that detects a state of the passing liquid (beer) 20. That is, a refractive index of light traveling from the light emitting element 121 to the light receiving element 122 varies depending on whether an object passing through the supply pipe 30 is a liquid, gas, or a mixture thereof. Therefore, the amount of light received by the light receiving element 122 varies depending on the object passing through the supply pipe 30.

As described above, the light emitting element 121 and the light receiving element 122 are electrically connected to the control device 130 to be described below, and the control device 130 detects a change in the amount of received light, and determines that the passing object turns into a gas.

Next, as described above, the control device 130 is a device that is electrically connected to the liquid-absence detection device 120 and gives instructions to close a flow path in the dispensing device 50 in response to the detection of the absence of the liquid in the storage container, and is configured with a computer.

That is, as described in the section “PROBLEMS TO BE SOLVED BY THE INVENTION”, when the beer in the beer barrel 10 runs out and the beer barrel is replaced with a new beer barrel filled with beer, in other words, when the detection with the liquid-absence detection device 120 is performed, in a state where the dispensing outlet 54 of the dispensing device 50 remains open, “stale” beer is obtained. In order to prevent the beer from being stale and reduce, for example, a loss of the beer, the control device 130 gives the instructions closing the flow path in the dispensing device 50 in response to the detection of the absence of the liquid in the storage container by using the liquid-absence detection device 120.

Here, for example, a way of the instructions may be an alarm using such as sound and light for notifying the detection of the absence of the liquid in the storage container, and then such as a store clerk who recognizes the instructions may operate the lever 56 of the dispensing outlet 54 in the dispensing device 50 to close the flow path.

Further, as in the present embodiment, the control device 130 may instruct the closing device 140 described below so as to automatically close the flow path.

The closing device 140 is a device that is provided in the dispensing device 50, is electrically connected to the control device 130 as described above, and closes the flow path in the dispensing device 50 according to the instructions closing the flow path from the control device 130. An installation place of the closing device 140 in the dispensing device 50 is not particularly limited, but the vicinity of the dispensing outlet 54 is preferable in terms of a space and also for the purpose of closing the flow path. Specifically, the closing device 140 corresponds to a mechanism such as an electromagnetic valve and a mechanism for crushing a resin tube in a case there is a flow path by the resin tube.

When the dispensing device 50 has an automatic liquid supply device as disclosed in the patent in Japan (No. 6180916) of the present applicant, the closing device 140 corresponds to a mechanism portion provided in the automatic liquid supply device and automatically operating the lever 56.

Conversely, it is also possible to apply a configuration including the spout prevention unit 110, the liquid-absence detection device 120, and the control device 130 in the present embodiment to the automatic liquid supply device if it has already installed.

Next, the pressure detection device 150 is electrically connected to the control device 130 and detects a pressure of the pressurized gas for transferring the liquid 20, and specifically corresponds to a device including such as a pressure sensor and a strain gauge. An installation position of the pressure detection device 150 corresponds to, for example, an outlet portion of the pressurization source 15, a pipe 30a portion between the storage container 10 and the spout prevention unit 110. FIG. 1 illustrates a configuration in which the pressure detection device 150 is disposed between the liquid-absence detection device 120 and the spout prevention unit 110 for the sake of convenience in illustration.

A role of the pressure detected by the pressure detection device 150 will be described in detail in the following operation description.

An operation of the liquid supply system 101 having the above configuration will be described below. Here, this explanation will be described with a configuration in which the liquid supply system 101 also includes the closing device 140 and the pressure detection device 150 provided in the modified configuration example.

A basic operation of the liquid supply system 101 is similar to the operation of the liquid supply system 70 illustrated in FIG. 6. That is, by using the pressurized gas (carbon dioxide gas) with the pressurization source 15, the liquid (beer) 20 in the storage container 10 is transferred, passes through the spout prevention unit 110 and enters to the dispensing device 50, in the dispensing device 50, the liquid (beer) 20 is cooled, and then it is dispensed from the dispensing outlet 54 to the drinking container 40 with the operation of the lever 56. At this time, the liquid-absence detection device 120 detects that a substance flowing through the supply pipe 30 is the liquid (beer) 20, the pressure detection device 150 sends detected pressure information to the control device 130, and the control device 130 does not perform any particular operation such as closing the flow path.

The spout prevention unit 110 in the liquid supply system 101 operates as follows. Normally, the discharge outlet 113a is closed by operating the air release lever 113b.

As described above, when the liquid (beer) 20 is normally transferred with the pressurized gas from the storage container 10 to the dispensing outlet 54 of the dispensing device 50, the inside of the spout prevention unit 110 is filled with the liquid 20 flowing into from the liquid inlet 111 and discharged from the liquid outlet 112, and the liquid 20 flows in this state within the spout prevention unit 110.

On the other hand, when the liquid 20 in the storage container 10 runs out during dispensing from the dispensing outlet 54, bubble-mixed liquid 20 is transferred within the supply pipe 30. Therefore, as described above, the liquid-absence detection device 120 detects a difference in refractive index of the substance passing through the supply pipe 30, and transmits the notification indicating that the liquid 20 in the storage container 10 runs out to the control device 130.

The bubble-mixed liquid 20 or the pressurized gas (carbon dioxide gas) further reaches the spout prevention unit 110, then pushes out the liquid 20 filled in the spout prevention unit 110 from the liquid outlet 112 to the supply pipe 30 arranged toward the dispensing device 50 side.

As just described, due to the spout prevention unit 110 having the predetermined internal volume V, it is possible to prevent the pressurized gas from being spouted out from the dispensing outlet 54 when the beer in the beer barrel 10 runs out.

At this time, the control device 130 instructs closing the flow path in the dispensing device 50 in response to the detection of the absence of the liquid in the storage container of the liquid-absence detection device 120. In the present embodiment, in response to the flow path closing instructions, the closing device 140 is activated, and for example, the flow path near the dispensing outlet 54 is closed.

As described above, in a configuration in which the closing device 140 is not provided, the store clerk operates the lever 56 of the dispensing outlet 54 in response to the flow path closing instructions to close the flow path. In the liquid supply system with the automatic liquid supply device, the lever 56 is automatically operated to close the flow path.

In this manner, by closing the flow path in the dispensing device 50, the discharge of the liquid 20 from the liquid outlet 112 of the spout prevention unit 110 is stopped. Therefore, at least the liquid on a downstream side from the liquid outlet 112 of the spout prevention unit 110 remains within the flow path as it is, and can be maintained with a state where the pressure by the pressurized gas acts. Accordingly, it is not necessary to discard at least the liquid 20 on the downstream side from the liquid outlet 112 when the storage container 10 is replaced, and the loss of the liquid 20 can be reduced.

As is clear from the above description, a time required until closing the flow path in the dispensing device 50 is performed after the liquid-absence detection device 120 detects the absence of the liquid in the storage container depends on, that is, is proportional to the internal volume V of the spout prevention unit 110, and depends on, that is, is inversely proportional to the pressure of the pressurized gas.

Therefore, the internal volume V of the spout prevention unit 110 is designed to be a volume that the liquid 20 within the spout prevention unit 110 is not replaced with the pressurized gas flowing into the spout prevention unit 110 through the liquid inlet 111 before the flow path in the dispensing device 50 is closed with the detection of the absence of the liquid in the storage container by using the liquid-absence detection device 120. In other words, the internal volume V is a volume exceeding an amount of liquid contained within the spout prevention unit 110 at a point in time when the liquid-absence detection device 120 detects the absence of the liquid in the storage container, and is a volume exceeding an amount of liquid in the spout prevention unit 110 replaced with the pressurized gas flowing into the spout prevention unit 110 through the liquid inlet 111 of the spout prevention unit 110 in a period from a time that the absence of the liquid in the storage container is detected by the liquid-absence detection device 120 to a time that the flow path in the dispensing device 50 is closed.

As an example, the internal volume V of the spout prevention unit 110 is 100 cc when the pressure of the pressurized gas (carbon dioxide gas in the present embodiment) is 0.4 MPa.

The control device 130 can adjust a period of time or a timing of the instructions until the instructions closing the flow path in the dispensing device 50 is given after the liquid-absence detection device 120 detects the absence of the liquid in the storage container in response to at least one of the internal volume V of the spout prevention unit 110 and the pressure of the pressurized gas detected by the pressure detection device 150. Specifically, as an example, the control device 130 has relationship information between the internal volume V of the spout prevention unit 110 and the pressure of the pressurized gas, and the timing of the closing instructions, then the control device 130 performs adjustment based on the above relationship information.

Next, after the flow path in the dispensing device 50 is closed or at the same timing as the closing the flow path, the store clerk replaces the empty storage container 10 with a new storage container 10 filled with the liquid 20. Then, the liquid 20 in the new storage container 10 is introduced into the supply pipe 30, and transferring the liquid 20 with the pressurized gas is started. At this time, the air release lever 113b of the spout prevention unit 110 is operated to open the discharge outlet 113a such that the gas (carbon dioxide gas) present inside the spout prevention unit 110 is not discharged from the liquid outlet 112 to the supply pipe 30. Due to this operation, the gas remaining at the upper portion within the spout prevention unit 110 and even the bubble-mixed liquid 20 are discharged from the discharge outlet 113a to the outside of the spout prevention unit 110 by the liquid 20 transferred with the pressurized gas and flowing into the spout prevention unit 110, and thus, the inside of the spout prevention unit 110 is filled with the liquid 20 from the new storage container 10.

In the present embodiment, the above exhausting operation is performed visually by the store clerk through the visual recognition unit 114 disposed adjacent to the exhaust mechanism 113 in the spout prevention unit 110.

Then, the air release lever 113b is operated to close the discharge outlet 113a at a point in time when the internal volume V of the spout prevention unit 110 is filled with the liquid 20. With this, the liquid supply system 101 returns to a normal operation.

Thereafter, the liquid 20 passes through the spout prevention unit 110 and flows to the dispensing device 50 side with an opening operation of the lever 56 in the dispensing outlet 54.

As described above, according to, using the spout prevention unit 110, and the exhausting and liquid filling operation using the exhaust mechanism 113, when the empty storage container 10 is replaced with the new storage container 10, the amount of loss of the liquid 20 is substantially only the amount of liquid 20 mixed with the pressurized gas present between the storage container 10 in which the liquid 20 runs out and the spout prevention unit 110. Therefore, according to the liquid supply system 101, the amount of loss of the liquid 20 can be greatly reduced as compared with the case in the related art.

In the present embodiment, as described above, the exhausting within the spout prevention unit 110 is performed with the operation and visual recognition of the store clerk. However, for example, by arranging an optical sensor and an opening/closing valve at a portion such as the discharge outlet 113a, it is possible to make the exhausting operation be automated by, for example, operation control of the control device 130 to fill the liquid.

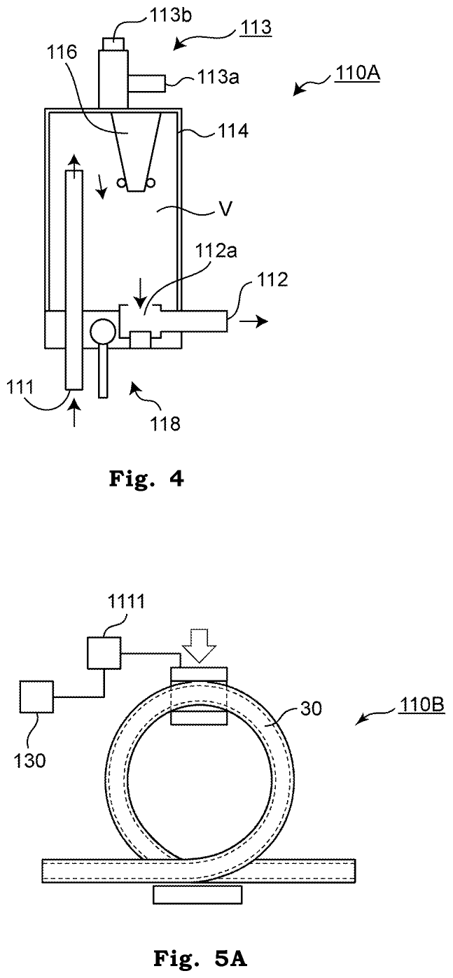

In the present embodiment, the spout prevention unit 110 has a configuration as illustrated in FIG. 2, but a spout prevention device 110A having a configuration as illustrated in FIG. 4 can also be used.

The spout prevention device 110A corresponds to one of the spout prevention devices 60 illustrated in FIG. 6, and further includes a float 116 and a float push-up mechanism 118 in addition to the configuration of the spout prevention unit 110.

The spout prevention device 110A having such a configuration operates as follows.

That is, when the liquid 20 flows through the internal volume V, the float 116 floats in the liquid 20. On the other hand, when the liquid 20 within the storage container 10 runs out and the pressurized gas flows into the spout prevention device 110A, a liquid level within the spout prevention device is pushed down and the float 116 descends, and then the float 116 is fitted into an inlet 112a. At this time, hermetically sealed between the fitted float 116 and the inlet 112a can be kept with an O-ring provided on the float 116.

With such an operation, the pressurized gas is prevented from entering it to the dispensing device 50 side from the liquid outlet 112, then the pressurized gas is prevented from being spouted out from the dispensing outlet 54 when the beer in the beer barrel 10 runs out.

Here, the float push-up mechanism 118 is a mechanism that forcibly separates the float 116 fitted into the inlet 112a from the inlet 112a by operating a lever 118a. After the replacement with the new storage container 10, the float push-up mechanism is operated after the liquid is filled in the internal volume V, then opens the liquid outlet 112 of the spout prevention unit 110.

Such a spout prevention device 110A has a slightly more complicated structure compared with the spout prevention unit 110, however has an advantage that it is possible to reliably close the flow of the pressurized gas into the dispensing device 50 side when the beer in the beer barrel 10 runs out.

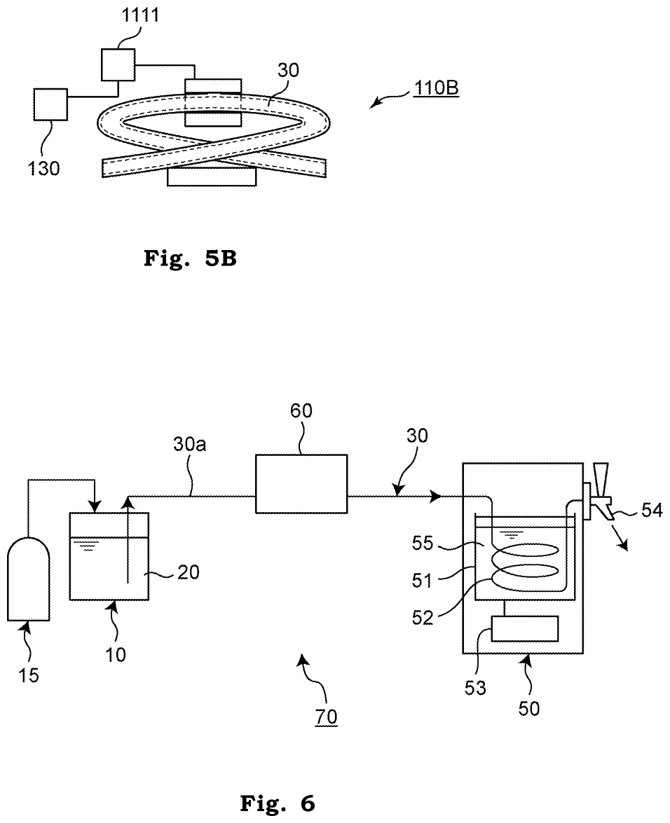

In place of the spout prevention unit 110, a spout prevention device 110B illustrated in FIGS. 5A and 5B corresponding to one of the spout prevention devices 60 illustrated in FIG. 6 can also be used. The spout prevention device 110B is a device disclosed in the patent in Japan (No. 4986687) of the present applicant. A brief description will be given below.

The spout prevention device 110B includes, as a configuration example, a supply pipe 30 arranged in a loop shape and a moving mechanism 1111 that moves a holding unit holding the supply pipe 30. In the spout prevention device 110B, the moving mechanism 1111 moves the supply pipe 30 in an arrow direction under the control of the control device 130 with the detection of the liquid-absence detection device 120. Due to this operation, the supply pipe 30 is bent and crushed, and the flow path is blocked. The supply pipe 30 of which the flow path is blocked is returned by the moving mechanism 1111.

As described above, according to the liquid supply system 101 of the present embodiment, when the empty storage container 10 is replaced with the new storage container 10, the amount of loss of the liquid 20 is substantially only the amount of liquid 20 mixed with the pressurized gas present between the storage container 10 in which the liquid 20 runs out and the spout prevention unit 110. Therefore, the amount of loss of the liquid 20 can be significantly reduced as compared with the case in the related art.

By appropriately combining arbitrary embodiments among the various embodiments described above, it is possible to obtain combined effects with each embodiment.

Although the present invention has been fully described in connection with preferred embodiments thereof with reference to the accompanying drawings, various changes and modifications will be apparent to those skilled in the art. It is to be understood that such changes and modifications are intended to be included therein without departing from the scope of the invention as set forth in the appended claims.

All the disclosure contents of the specification, drawings, claims, and abstract of Japanese Patent Application No. 2020-160868 filed on Sep. 25, 2020 are incorporated herein by reference.

### INDUSTRIAL APPLICABILITY

The present invention is applicable to a liquid supply system for transferring a liquid in a storage container with pressurized gas and dispensing the liquid from a dispensing device into a drinking container.

### DESCRIPTION OF REFERENCE SYMBOLS

10 STORAGE CONTAINER
20 LIQUID
30 SUPPLY PIPE
40 DRINKING CONTAINER
50 DISPENSING DEVICE
54 LIQUID DISPENSING OUTLET
70 LIQUID SUPPLY SYSTEM
101 LIQUID SUPPLY SYSTEM
110, 110A, 110B SPOUT PREVENTION UNIT
111 LIQUID INLET
112 LIQUID OUTLET
113 EXHAUST MECHANISM
114 VISUAL RECOGNITION UNIT
120 LIQUID-ABSENCE DETECTION DEVICE
130 CONTROL DEVICE
140 CLOSING DEVICE
150 PRESSURE DETECTION DEVICE

1. A liquid supply system that supplies a liquid in a storage container to a dispensing device through a supply pipe with a pressurized gas, and dispenses the liquid to a drinking container from a dispensing outlet in the dispensing device, the liquid supply system comprising:
a spout prevention unit being installed in the supply pipe, having a tubular shape with a predetermined internal volume, having a liquid inlet and a liquid outlet connected to the supply pipe, and preventing the pressurized gas from being spouted from the dispensing outlet;
a liquid-absence detection device being installed between the storage container and the spout prevention unit, and detecting absence of the liquid in the storage container; and
a control device being electrically connected to the liquid-absence detection device, and giving instructions to close a flow path in the dispensing device in response to the detection of the absence of the liquid in the storage container.

2. The liquid supply system according to claim 1, further comprising: a closing device being installed in the dispensing device, being electrically connected to the control device, and closing the flow path according to the instructions for closing the flow path with the control device.

3. The liquid supply system according to claim 2, wherein the internal volume in the spout prevention unit is a volume exceeding an amount of liquid in the spout prevention unit replaced with the pressurized gas flowing into the spout prevention unit from the liquid inlet in a period from a time that the absence of the liquid in the storage container is detected by the liquid-absence detection device to a time that the closing device closes the flow path.

4. The liquid supply system according to claim 1, further comprising:
a pressure detection device being electrically connected to the control device, and detecting a pressure of the pressurized gas,
wherein the control device adjusts a timing of instructions to stop the dispensing of the liquid in response to the pressure detected by the pressure detection device.

5. The liquid supply system according to claim 1, wherein the spout prevention unit further includes an exhaust mechanism exhausting the pressurized gas flowing into the spout prevention unit to an outside of the spout prevention unit, and a visual recognition unit being provided adjacent to the exhaust mechanism and through which an inside of the spout prevention unit is able to be seen.

6. A liquid loss reduction method executed by a liquid supply system that supplies a liquid in a storage container to a dispensing device through a supply pipe with a pressurized gas, and dispenses the liquid to a drinking container from a dispensing outlet in the dispensing device, the liquid supply system having a spout prevention unit having a tubular shape with a predetermined volume, having a liquid inlet and a liquid outlet connected to the supply pipe, and preventing the pressurized gas from being spouted from the dispensing outlet, the method comprising;
closing a flow path in the dispensing device before a liquid in the spout prevention unit is replaced with the pressurized gas flowing into the spout prevention unit from the liquid inlet when the liquid within the storage container runs out.

7. The liquid loss reduction method according to claim 6, wherein due to replacement with a new storage container after the flow path is closed, a new liquid is filled within the spout prevention unit while the pressurized gas flowing into the spout prevention unit is exhausted to an outside of the spout prevention unit by using an exhaust mechanism of the spout prevention unit.
